(19) United States
(12) Patent Application Publication
(10) Pub. No.: US 2015/0362325 A1
(43) Pub. Date: Dec. 17, 2015

(54) SCHEME FOR UPDATING NAVIGATION THROUGH COMMUNICATION WITH USER EQUIPMENT

(71) Applicant: Samsung Electronics Co., Ltd., Gyeonggi-do (KR)

(72) Inventors: In-Young SHIN, Seoul (KR); Se-Hee Han, Seoul (KR); A-Ram Cho, Gyeonggi-do (KR); Ju-Ho Lee, Gyeonggi-do (KR); Hee-Won Jung, Gyeonggi-do (KR)

(73) Assignee: Samsung Electronics Co., Ltd.

(21) Appl. No.: 14/736,894

(22) Filed: Jun. 11, 2015

(30) Foreign Application Priority Data
Jun. 11, 2014 (KR) 10-2014-0070954

(51) Int. Cl. G01C 21/36; H04W 4/04; G06F 17/30

(52) U.S. Cl. CPC G01C 21/36; G06F 17/30241; G06F 17/30345; H04W 4/04; H04W 88/02

(57) ABSTRACT

The present disclosure relates to a sensor network, Machine Type Communication (MTC), Machine-to-Machine (M2M) communication, and technology for Internet of Things (IoT). The present disclosure may be applied to intelligent services based on the above technologies, such as smart home, smart building, smart city, smart car, connected car, health care, digital education, smart retail, security and safety services. A method of and device for updating a navigation device through communication with a User Equipment (UE). The method includes recognizing at least one of a location and an object as a Point of Interest (POI), based on a user preference set in advance or a user's input; transmitting, to the UE, a request for additional data associated with the location or the object; receiving, from the UE, the additional data associated with the location or the object through the communication; and updating the navigation device using the additional data.

### PRIORITY

This application claims priority under 35 U.S.C. §119(a) to a Korean Patent Application Serial filed on Jun. 11, 2014 in the Korean Intellectual Property Office and assigned Serial No. 10-2014-0070954, the entire content of which is incorporated herein by reference.

### BACKGROUND

1. Field of Invention

The present invention relates generally to a scheme for updating a vehicle navigation, and more particularly, to a method and apparatus for updating a vehicle navigation using a user equipment including a communication function.

2. Description of the Related Art

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology,” “wired/wireless communication and network infrastructure,” “service interface technology,” and “security technology” have been demanded for IoT implementation, a sensor network, a Machine-to-Machine (M2M) communication, Machine Type Communication (MTC), and so forth have been recently researched.

Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

Navigation services are services that inform of a current location of a vehicle, calculate an optimum path for reaching a desired destination, show the calculated path in advance during traveling of the vehicle, thereby guiding a driver. A device that supports navigation services may obtain a current location of a vehicle using a Global Positioning System (GPS), and provide the navigation services based on the location information.

A navigation device provided internal to a vehicle may update information used for navigation, using limited information such as Car Area Network (CAN) information (e.g., information input through a sensor of the vehicle, information indicating the degree that a driver steps on the accelerator, etc.) provided from the vehicle.

Three known methods for updating a navigation device provided in a vehicle using a network external to the vehicle such as the Internet are as follows.

The first method is a method in which the navigation device is directly connected to an information providing server on the Internet to download and update data, using tethering technology provided by mobile communication equipment such as a smartphone which a driver carries. According to this method, the navigation device may update the whole of map data or Point of Interest (POI) data files at once, or perform a partial update operation by downloading only required map data or POI data in real-time. However, in the method of using the tethering technology of the smartphone, it is necessary for a user to manually connect the smartphone and the navigation device and it is necessary to perform an update operation at a certain time point, and therefore the user may be reluctant to do so. In addition, when the navigation device updates the whole of the map or POI data files using the tethering technology, a significant amount of bandwidth of the smartphone may be consumed, and even when it updates only the required data in real-time, it is necessary to always turn on the tethering connection of the smartphone, which results in consuming significant amounts of data and battery power of the smartphone. In addition, the navigation device may rely on only information provided by the navigation device itself or a software providing company, and thereby the update frequency is slow and the accuracy of the provided information cannot be ensured.

The second method is a method in which a navigation device receives and updates data using terrestrial frequencies such as Transport Protocol Expert Group (TPEG). However, through most of the terrestrial frequencies for Digital Multimedia Broadcast (DMB) channel which are used in TPEG, the data transfer speed is slow and only one-way communication is possible. In addition, data transmission through the terrestrial frequencies may require the construction of infrastructure, and therefore, inevitably, there are application limitations for each nation or region.

The third method is a method in which a navigation device is directly connected to an information providing server through a 3rd Generation (3G) modem separately mounted in a vehicle and thereby performs an update operation. However, the fact that the percentage of vehicles equipped with a 3G modem is currently low and a separate data charge for a 3G modem is imposed act as obstructive factors of an updating method through a 3G modem.

### SUMMARY

The present invention has been made to address the above-mentioned problems and disadvantages, and to provide at least the advantages described below.

Accordingly, an aspect of the present invention is to provide a method and apparatus in which a navigation device of a vehicle downloads data in real-time and updates information using a smartphone.

Another aspect of the present invention is to provide a method and apparatus for receiving and updating a variety of additional data through a smartphone based on location information or user selection object information which are generated in a navigation device.

Another aspect of the present invention is to provide a method and apparatus for enhancing navigation services using accessibility to a significant amount of information provided from a smartphone.

Another aspect of the present invention is to provide a method and apparatus in which a navigation device receives a variety of information using a smartphone to update a navigation DataBase (DB), performs streaming (e.g. mirroring) output of a screen of the smartphone, or enhances navigation display information through an output scheme such as an overlay.

Another aspect of the present invention is to update the navigation device using rich information collected through the smartphone.

Another aspect of the present invention is for the navigation device to achieve optimal consumption of battery power and bandwidth as well as achieving easy access to the Internet and a frequent update operation by using a smartphone, thereby maximizing a user's convenience when updating the navigation device.

In accordance with an aspect of the present invention, there is provided a method of updating a navigation device through communication with a User Equipment (UE). The method includes recognizing at least one of a location and an object as a Point of Interest (POI), based on a user preference which is set in advance or a user's input; transmitting, to the UE, a request for additional data associated with the location or the object; receiving, from the UE, the additional data associated with the location or the object through the communication; and updating the navigation device using the additional data.

In accordance with another aspect of the present invention, there is provided a method of supporting update of a navigation device through communication with a UE. The method includes receiving a request for additional data associated with one or more locations or objects from the navigation device; collecting the additional data associated with the one or more locations or objects from an information server on an Internet through cellular communication or Wireless-Fidelity (Wi-Fi) communication; and transmitting the collected additional data to the navigation device through the cellular communication or Wi-Fi communication.

In accordance with another aspect of the present invention, there is provided a navigation device for performing an update operation through communication with a UE The navigation device is configured to recognize at least one of a location and an object as a POI based on a user preference which is set in advance or a user's input, transmit a request for additional data associated with the location or the object to the UE, receive the additional data associated with the location or the object from the UE through the communication, and update the navigation device using the additional data.

In accordance with another aspect of the present invention, there is provided a UE for supporting update of a navigation device through communication. The UE is configured to receive a request for additional data associated with at least one of a location and an object from the navigation device, collect the additional data associated with the location or the object from an information server on an Internet through cellular communication or Wi-Fi communication, and transmit the collected additional data to the navigation device through the cellular communication or the Wi-Fi communication.

### BRIEF DESCRIPTION OF THE DRAWINGS

The above and other aspects, features, and advantages of the present invention will be more apparent from the following detailed description, taken in conjunction with the accompanying drawings, in which:

FIG. 1 is a diagram illustrating a scheme for updating a navigation device according to an embodiment of the present invention;

FIG. 2 is a flow diagram of an interaction between a navigation device and a UE according to an embodiment of the present invention;

FIGS. 3A and 3B illustrate an example of a screen output when a navigation DB is updated according to an embodiment of the present invention;

FIG. 4 illustrates an example of a screen output when mirroring a navigation screen according to an embodiment of the present invention;

FIG. 5 illustrates an example of a screen output when overlaying a navigation screen according to an embodiment of the present invention;

FIG. 6 is a flowchart of a method of updating a navigation device according to an embodiment of the present invention;

FIG. 7 is a flowchart of a method of supporting navigation update of a UE according to an embodiment of the present invention;

FIG. 8 is a block diagram of a navigation device according to an embodiment of the present invention; and

FIG. 9 is a block diagram of a UE according to an embodiment of the present invention.

### DETAILED DESCRIPTION OF EMBODIMENTS OF THE PRESENT INVENTION

Hereinafter, embodiments of the present invention are described in detail with reference to the accompanying drawings. In the following description of the present invention, a detailed description of known configurations or functions incorporated herein are omitted when the detailed description may make the subject matter of the present invention unclear. Meanwhile, terms described below are defined in consideration of the functions of the present invention, but the meanings of the terms may be changed according to a user, intention of an operator, or convention. Accordingly, the definitions of the terms should be made on the basis of the overall context of the embodiments of the present invention.

In the detailed description of the present invention, an example of interpretable meanings of some terms used in the present disclosure is provided. However, it is noted that the terms are not limited to the examples of the construable meanings which are provided below.

A navigation device may be a device that provides navigation services, and may be referred to as a “navigator” or a “navigation.” When mobile equipment such as a smartphone provides navigation services, such a smartphone may also be referred to as a “navigation device.” However, in the present disclosure, in order to distinguish a navigation device that does not include a cellular communication function from a smartphone having a cellular communication function, the navigation device and the smartphone may be referred to separately. The navigation device according to the present invention may be a device that enables Peer to Peer (P2P) communication with a smartphone.

A smartphone is a mobile communication device that is capable of installing and driving various applications and has a cellular communication function and a P2P communication function. A smartphone according to the present invention does not simply refer to only a device in the form of a mobile phone, but is a concept of collectively referring to all smart devices such as a tablet Personal Computer (PC). The smartphone may be referred to as a User Equipment (UE), a Mobile Station (MS), Mobile Equipment (ME), a device, a terminal, or the like.

The P2P communication is direct communication that can be established between a navigation device and a mobile communication device of a user such as a smartphone. For example, a navigation device and a smartphone may apply various communication standards such as Wireless Fidelity (Wi-Fi) Direct, Bluetooth, Zigbee, Internet Protocol Version 6 (IPv6) over Low power Wireless Personal Area Networks (6LoWPAN), etc., thereby establishing a P2P communication.

An operation of updating a navigation may include an operation of changing (e.g. adding or replacing) a DataBase (DB) of the navigation using additional data, or changing (e.g. adding or replacing) a displayed screen using the additional data.

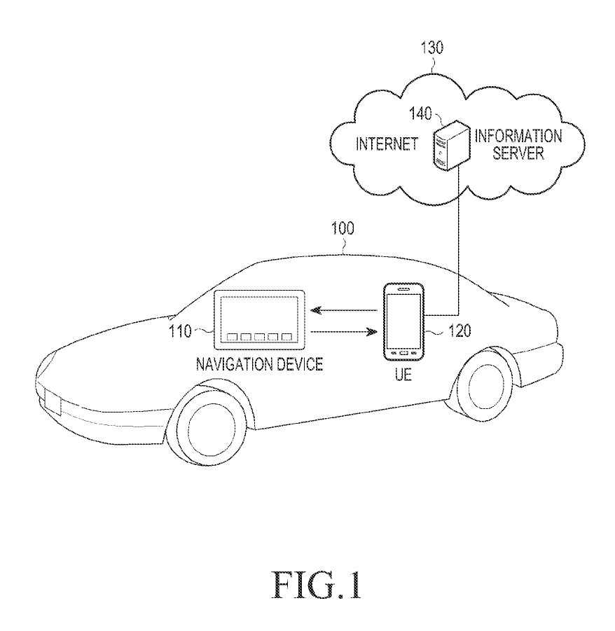

FIG. 1 is a diagram illustrating a scheme for updating a navigation device according to an embodiment of the present invention.

Referring to FIG. 1, a navigation device 110 provided inside a vehicle 100 may set a P2P connection with a mobile communication device (such as a UE or a smartphone) carried by a user (or a driver), automatically or by a user's operation. Accordingly, the navigation device 110 may indirectly communicate with significantly various information servers 140 existing on the Internet 130 through a UE (e.g., a smartphone) 120. That is, in the present invention, the UE 120 of the user may act as a source of information that can provide significantly rich data to the navigation device 110. Meanwhile, the connection with the UE 120 through the P2P communication of the navigation device 110 may be distinguished from a connection through tethering, in that it does not cause bandwidth consumption and battery power consumption of the UE 120.

When communication and interlocking between the UE 120 and the navigation device 110 are possible as provided in the present invention, the navigation device 110 can easily access the Internet, which is an advantage of the UE 120. In addition, the navigation device 110 may perform a frequent update operation, and the UE 120 may achieve optimal consumption of battery power and bandwidth, thereby maximizing the user's convenience.

The navigation device 110 may transmit location information of a certain location or object information selected by a user to the UE 120 through the P2P communication, by a user's operation or a predetermined rule.

The UE 120 may collect a variety of additional data corresponding to the location information or the object information from the information servers 140 on the Internet 130 through cellular communication or Wi-Fi communication, based on the received location information of the certain location or the received object information selected by the user.

The UE 120 may process the collected variety of additional data, and transmit the processed additional data to the navigation device 110 through the P2P communication. The processed and transmitted additional data may include interest information such as price information and coupon information which are changed in real-time according to the user's interests as well as basic information for providing the navigation services of the navigation device 110 such as map data, POI (point of interest) data, road information, geographical name information, etc.

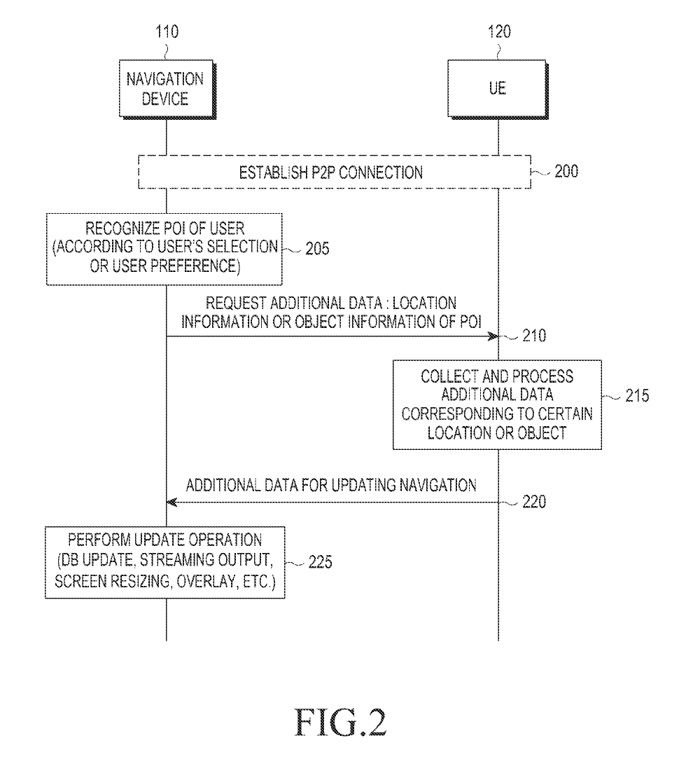

The navigation device 110 may receive the additional data from the UE 120, and update the navigation device in various schemes. Three exemplary methods are used as a method of updating the navigation device 110. That is, the navigation device 110 may update the navigation device 110 (that is, a DB of the navigation device 110) using the additional data received from the UE 120, output a screen that is provided in the form of the additional data from the UE 120 to its own screen (that is, a screen of the navigation device 110) as is, or resize its own screen (that is, the screen of the navigation device 110) and output the additional data received from the UE 120 directly to the resized screen. FIG. 2 is a flow diagram of an interaction between a navigation device and a UE according to an embodiment of the present invention.

In step 200, the navigation device 110 and the UE 120 may establish a P2P connection in advance. Selectively, when desiring to transmit location-related information to the UE 120 so as to update the navigation device 110, the navigation device 110 may establish the P2P connection.

In step 205, the navigation device 110 may recognize a certain location or a certain object through a user's selection such as a touch input to the screen of the navigation device 110 or according to whether the certain location or the certain object coincides with a predetermined user preference.

The user preference, for example, “new building,” “new store,” “large building,” and the like may be set in advance. In this case, the navigation device 110 may determine the certain location as an event for recognizing, as POIs, a new establishment (e.g. a grand opening) of department stores, discount stores, shopping malls, outlet stores, gas stations, bakeries, tall buildings, etc., and thereby automatically recognize the corresponding location as the POI. The recognition through the user's selection is a method in which a position specified by a user's selection in a map displayed on the screen of the navigation device is recognized as the POI. For example, whether an arbitrary building is newly built and whether an arbitrary store is newly opened may be determined by whether the registration date of the building or the store displayed in the navigation device is within an arbitrary period (e.g., one week, one month, two months, etc.) from the current date.

For example, when a newly opened department store is located within a threshold distance (e.g., 500 m, 1 km, or the like) from a current location of a vehicle or within an arbitrary distance from a predicted traveling path of the vehicle, the navigation device 110 may recognize the department store as the POI of the user.

In step 210, the navigation device 110 requests additional data by transmitting location information or object information corresponding to the recognized one or more POIs to the UE 120.

Selectively, the navigation device 110 may enable information indicating a desired data format to be further included in the additional data for the POI, and transmit the additional data.

In this case, the navigation device 110 may directly communicate with an application (e.g., a navigation application) installed in the UE 120.

Information indicating location may be Global Positioning System (GPS) coordinate information (e.g. latitude, longitude, altitude, etc.) or address information on the administrative districts. The certain object may be a text represented as a combination of at least one of a geographical name and a building's name. For example, the certain object may be represented as text indicating a building, a store, or the like such as “Nonhyun-Dong intersection S-oil”, “Gangnam station Kyobo building”, or “Constitutional Court.”

The desired data format of the navigation device 110 may be, for example, a data format (e.g., Structured Query Language (SQL) query result data) that is to be used to update a DB, a video streaming data format of a variety of types for displaying data on the screen of the navigation device 110, or a web data format (e.g., Extensible Markup Language (XML) file, widget file, image file, etc.) capable of reconfiguring and outputting data in the screen of the navigation device 110. When the desired data format of the navigation device 110 is a data format for updating a DB, the navigation device may transmit an SQL query for retrieving additional information of the location or the object as a request message.

In step 215, the UE 120 collects additional information corresponding to the location or the object using the location information or the object information received from the navigation device 110, and processes the collected additional information as additional data.

The processed and transmitted additional data may include interest information such as price information and coupon information which are changed in real-time according to the user's interests as well as basic information for providing the navigation services of the navigation device 110 such as map data, POI data, road information, geographical name information, etc. As examples of the basic information, information of detailed map data, POI information, new building information, newly opened road information, closed road information, and the like may be given. As examples of the POI information, price information of a certain gas station, price comparison information of gas stations, free car wash coupon information of gas stations or car washes, sale information of department stores, coupon information of department stores, and the like may be given.

The additional data may be information stored in various servers (e.g., a portal site, a search site, and the like) on the Internet, an information server operated/supported by a navigation hardware or software manufacturer, or the like, or information that has already been stored in the UE 120. The UE 120 may acquire additional information from the information server in real-time or process the additional information that has been stored in the UE 120 to thereby generate additional data to be transmitted. The UE 120 may store additional information for updating the navigation device 110 in advance in a Wi-Fi communicable environment, and therefore the UE 120 can transmit the additional data for updating the navigation device 110 even when it cannot access Wi-Fi or when a communication network (e.g., 3G or 4^{th} Generation (4G) network) of a communication company is not activated due to a charge imposition problem, or the like.

In step 220, the UE 120 transmits the processed additional data to the navigation device 110 through the P2P communication.

The additional data transmitted by the UE 120 includes a variety of additional information used to update the navigation device 110. Selectively, the additional data may be transmitted in a certain desired data format when the navigation device 110 requests the additional data in step 210. That is, the transmitted additional data may have a data format for updating a DB, a streaming data format, or a web data format such as a web widget, XML, an image file, or the like according to the desired data format.

In step 225, the navigation device 110 performs an update operation using the additional data.

The navigation device 110 may update the navigation device 110 (e.g. update a DB of the navigation device 110) using the additional data, perform a mirroring operation of outputting an image provided from the UE 120 to its own screen (that is, a screen of the navigation device 110) as is, or perform an overlay operation of resizing its own screen (that is, a screen of the navigation device 110) and outputting the additional data received from the UE 120 directly to the resized screen.

When updating the DB, the additional data which the navigation device 110 receives may be a result message for an SQL query or a set of information corresponding to the result. The navigation device 110 may update its own DB using the additional data. Accordingly, the navigation device 110 may display additional information about the certain location or the object on its own screen in the form of tooltips, icons, or buttons.

When performing the mirroring operation, the additional data that the navigation device 110 receives may be streaming data outputting an image. The image may be an image of a screen which is currently output to its own screen (e.g. the screen of the UE 120) using the information which the UE 120 receives from the information server on the Internet. The navigation device 110 may output the image to its own screen as is.

When performing the overlay operation, the additional data that the navigation device 110 receives may be web data such as a web widget, XML, an image file, or the like. The navigation device 110 may enable the web data to be included in its own screen by reconfiguring its own screen, or output the web data so as to appear superimposed on the whole or a part of its own screen.

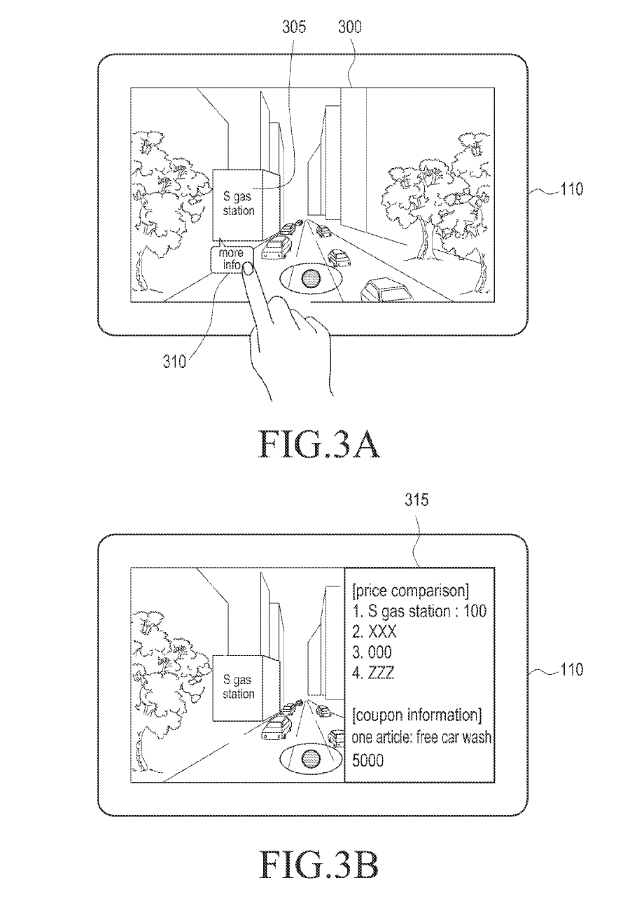

FIGS. 3A and 3B illustrate an example of a screen output when a navigation DB is updated according to an embodiment of the present invention.

Referring to FIG. 3A, an example of displaying the existence of additional data in a user's POI 305 on a screen of the navigation device 110 as a tooltip 310 is illustrated.

The navigation device 110 may store additional data of a certain location or an object which is received from the UE 120 in the DB. The navigation device 110 may display, on the screen 300, the tooltip 310 in a periphery (e.g., in an upper end or a lower end) of a gas station 305 corresponding to a user's interest existing in the vicinity of a current location of a vehicle, and notify the corresponding user of the existence of updated additional information in the gas station 305.

Referring to FIG. 3B, an example of displaying an additional information output window when a user's selection is input with respect to a tooltip notifying additional information about a POI on the screen of the navigation device 110 is illustrated.

When the tooltip 310 is selected by a user, the navigation device 110 may output a window 315 for displaying additional information about the selected gas station 305 to the whole or a part of the screen 300. The window 315 may include, for example, at least one of additional information such as price information of the gas station, price comparison information, free car wash coupon information provided from the gas station, and the like.

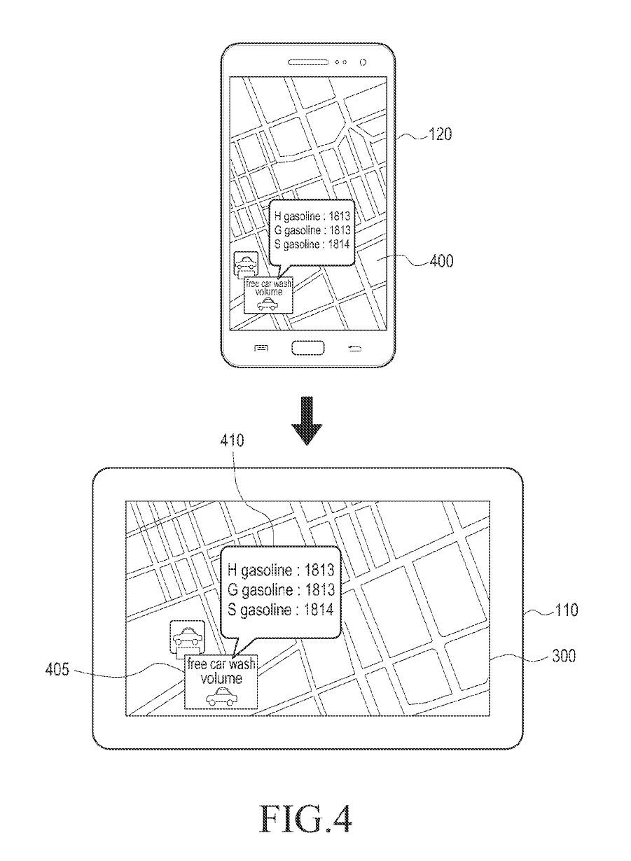

FIG. 4 illustrates an example of a screen output when mirroring a navigation screen according to an embodiment of the present invention.

Referring to FIG. 4, the navigation device 110 may output an image 400 provided in a streaming scheme by the UE 120 to its own screen 300 (that is, the screen of the navigation device 110) within a certain period of time and certain range.

That is, the image 400 configured by the UE 120 may be streaming-output from the screen 300 of the navigation device 110. The image 400 configured by the UE 120 may be configured so as to include a variety of additional information about a certain location or an object, which is acquired from a variety of information servers on the Internet.

The certain location or the object may be a location or an object which is set as a POI by a user or determined as the POI of the user by the navigation device 110.

The image output to the navigation device 110 may be configured in such a manner that the additional information about the certain location or the object is included in an area such as a tooltip 405 or a dialog box 410. The additional information may include, for example, at least one of interest information such as price information of a gas station, price comparison information, free car wash coupon information provided from the gas station, and the like.

In this case, selectively, the image may be an enlargement of the certain location or the object. When the certain location or the object is located in the vicinity of a current location of a vehicle (within a threshold distance) or in the vicinity of a predicted path of the vehicle (within a threshold distance), the navigation device 110 may display the certain location or the object on the screen by further zooming-in on the certain location or the object.

In this case, the “certain period of time” refers to a time displayed in a certain scheme in order for the navigation device 110 to notify a user of the existence of the certain location or the object or the expected access to the certain location or the object. For example, the certain period of time may refer to an arbitrary fixed time such as 5 seconds or 10 seconds, or refer to a period of time during which a user is located within a certain distance (e.g., 500 m, 1 km, or the like) from the certain location or the object. The reason why the time that is mirrored in this manner is limited as the “certain period of time” is because a screen displaying the certain location or the object in the certain scheme does not reflect a navigation screen based on the current location of the vehicle and this may thereby act as an obstacle to a user's safe driving when a display time is increased. The certain scheme refers to a scheme of displaying the certain location or the object by enlarging or zooming-in on the certain location or the object, or a scheme of additionally displaying a tooltip or a dialog window.

In this case, the “certain range” refers to a range displayed in a certain scheme in order for the navigation device 110 to notify a user of the existence of the certain location or the object or the expected access to the certain location or the object. For example, the certain range may be a threshold value (e.g., 500 m, 1 km, or the like) of a distance in which the vehicle is spaced apart from the certain location or the object.

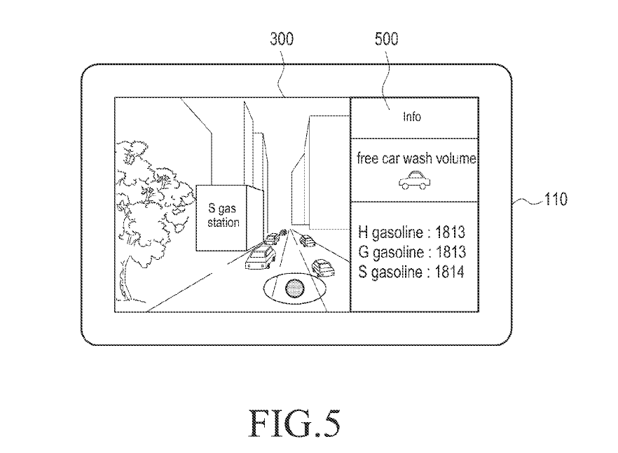

FIG. 5 illustrates an example of a screen output when overlaying a navigation screen according to an embodiment of the present invention.

Referring to FIG. 5, the navigation device 110 may output additional information about a certain location or an object to the whole or a part of its own screen 300 (that is, the screen of the navigation device 110) using web data provided from the UE 120.

The navigation device 110 may perform a screen re-configuration operation such as reducing an image that has already been output in order to ensure an area for outputting the additional information or moving an output position in a certain direction (to the left, the right, the top, the bottom, or the center). Next, the navigation device 110 may output the additional information about the certain location or the object to the whole or a part of the area ensured by the screen re-configuration operation.

In FIG. 5, an example in which an image that has been output is reduced and displayed on the left side of the screen 300 of the navigation device 110 and a window 500 for additional information is output on the right side of the screen 300 is illustrated. The window may be provided in the form of a tooltip, a dialog window, a button, or an icon. The additional information included in the window may be, for example, at least one of interest information such as price information of a gas station, price comparison information, free car wash coupon information provided from the gas station, and the like.

The navigation device 110 may output the window including the additional information within a certain period of time or a certain range, and stop, when exceeding the certain period of time or the certain range, the output of the window (e.g. removing the window from the screen) and output the previously output screen to the entire screen by resizing the previously output screen to have the original size.

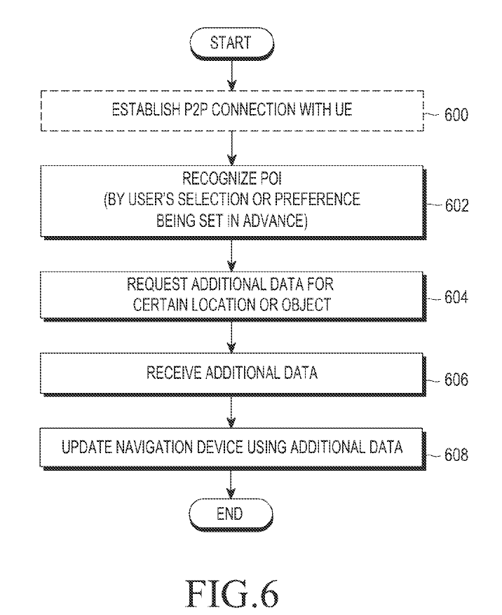

FIG. 6 is a flowchart of a method of updating a navigation device according to an embodiment of the present invention.

Selectively, in step 600, the navigation device may perform an operation of establishing a P2P connection with a UE. Alternatively, when desiring to request additional information for update from the UE 120, the navigation device may perform the operation of establishing the P2P connection.

In step 602, the navigation device recognizes a certain location or a certain object as a POI of a user. The recognition of the POI may be performed by a user's selection such as a touch input to a navigation screen or by a user preference set in advance. In addition, the recognition of the POI may also be performed by “recommendation” of the navigation device.

In step 604, the navigation device requests additional data corresponding to the recognized one or more POIs from the UE through the P2P communication. In the request (e.g. request message), location information or object information of the one or more POIs is included. Selectively, in the request, information indicating a desired data format for the additional data may be further included.

The location information may be GPS coordinate information or address information on the administrative districts. The object information may be text-based information, and may be represented as geographical names indicating buildings, stores, and the like. For example, the object information may be represented as “Nonhyun-Dong intersection S-oil”, “Gangnam station Kyobo building”, or “Constitutional Court”.

In step 606, the navigation device receives, from the UE, additional data about the certain location through the P2P communication in response to the request. The additional data that the navigation device receives may include a variety of additional information used to update the navigation device. Selectively, the additional data may be received in the desired data format requested by the navigation device. That is, the received additional data may have, for example, a data format for updating a DB, a streaming data format, or a web data format such as a web widget, XML, an image file, or the like.

In step 608, the navigation device performs an update operation using the received additional data. The navigation device may update its own DB using the additional data, perform a mirroring operation of outputting an image provided from the UE to its own screen as is, or perform an overlay operation of resizing its own screen and outputting the additional data directly to the resized screen.

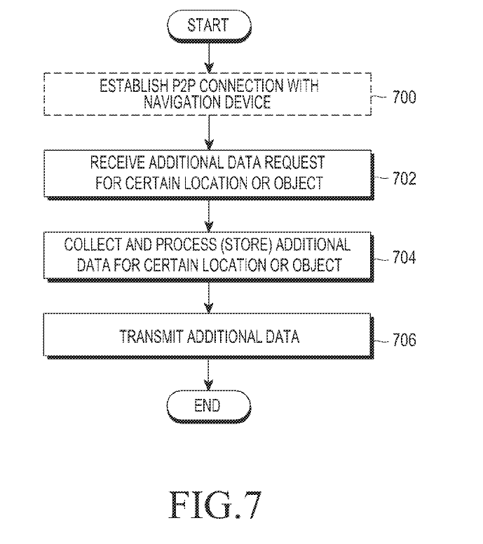

FIG. 7 is a flowchart of a method of supporting navigation update of a UE according to an embodiment of the present invention.

Referring to FIG. 7, selectively, in step 700, a UE may perform an operation of establishing a P2P connection with a navigation device. Alternatively, before receiving an additional information request for update from the navigation device, the UE may perform the operation of establishing the P2P connection by triggering of the navigation device.

In step 702, the UE receives an additional data request (e.g. request message) for one or more certain locations or objects from the navigation device. The certain location or the object is a target that is selected as a POI of a user by internal setting of the navigation device or a user's selection. In the request (e.g. request message), location information or object information of the one or more certain locations (or the objects) is included. Selectively, in the request, information indicating a desired data format for the additional data may be further included.

In step 704, the UE collects additional information of the one or more certain locations or objects from a variety of information servers on the Internet through cellular communication or Wi-Fi communication, and processes the collected additional information to have a data format for transmitting the corresponding information to the navigation device. Selectively, the UE may store the collected additional information in its own storage unit. The information stored in this manner may be used as additional data for update of the navigation device when the UE cannot perform Wi-Fi communication or when performing cellular communication is improper due to a cost issue or the like.

In step 706, the UE transmits the processed additional data to the navigation device. Selectively, the additional data may be transmitted in the desired data format requested by the navigation device. That is, the transmitted additional data may have, for example, a data format for updating a DB, a streaming data format, or a web data format such as a web widget, XML, an image file, or the like.

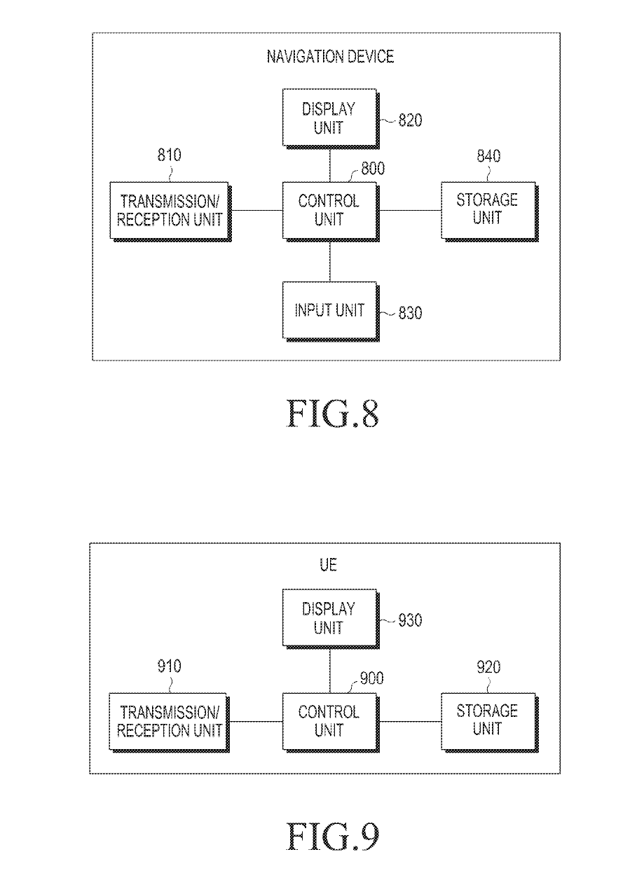

FIG. 8 is a block diagram of a navigation device according to an embodiment of the present invention.

Referring to FIG. 8, a navigation device may include at least one of a transmission/reception unit 810 that transmits and receives signals to and from a UE through P2P communication, a display unit 820 that displays a screen, an input unit 830 that receives information, commands, and selections from a user, and a control unit 800 that controls operations of the transmission/reception unit 810, the display unit 820, and the input unit 830. In addition, the navigation device may further include a storage unit 840 that stores transmitted and received data. In the storage unit 840, additional data for an update received from the UE, DB files, and the like may be stored.

The display unit 820 may include a touch screen that recognizes a user's touch such as Light Emitting Diode (LED) display, a Liquid Crystal Display (LCD), a Thin Film Transistor LCD (TFT LCD), an Organic LED (OLED) display, an Active Matrix Organic LED (AMOLED) display, a flexible display, a three-Dimensional (3D) display, or the like. The display unit 820 may also perform the function of the input unit 830, and in this case, the input unit 830 may not be included in the navigational device.

The input unit 830 may correspond to the same component as the display unit 820, and include a microphone or a voice recognition module for recognizing a user's voice. Using the input unit 830, the navigation device may perform an update operation by receiving an input of a POI whose additional information is desired to be obtained through a user's voice.

The control unit 800 can be interpreted to perform all of the above-described operations of the navigation device 110. That is, the control unit 800 may control at least one of an operation of recognizing a user's POI, requesting additional data about a certain location recognized as the POI from the UE, receiving the additional data from the UE, and updating the navigation device using the received additional data, by controlling the display unit 820, the transmission/reception unit 810, the input unit 830, and the storage unit 840.

In FIG. 8, the navigation device includes a plurality of divided components, but at least two of the components may be implemented as a single component. For example, the control unit 800, the transmission/reception unit 810, and the storage unit 840 may be implemented as a single module.

FIG. 9 is a block diagram of a configuration of a UE according to an embodiment of the present invention.

Referring to FIG. 9, a UE may include at least one of a transmission/reception unit 910 that receives data from information servers on the Internet through cellular communication or Wi-Fi communication and performs P2P communication with a navigation device and a control unit 900 that controls the operation of the transmission/reception unit 910. In addition, the UE may further include at least one of a storage unit 920 that stores data received from information servers on the Internet and a display unit 930 that displays a screen.

The control unit 900 can be interpreted to perform all of the above-described operations of the UE 120. That is, the control unit 900 may control at least one of an operation of receiving an additional data request for a certain location from the navigation device, collecting additional information about the certain location from information servers on the Internet, processing the additional data to be transmitted, and transmitting the processed additional data to the navigation server, by controlling the transmission/reception unit 910 or the storage unit 920.

It should be noted that a configuration diagram of a system, an example of navigation update procedures using the UE, a screen of a certain example of a method for updating the navigation device, an example of a method for updating the navigation device, an example of a method for supporting navigation update of the UE, a configuration example of the navigation device, and a configuration example of the UE which are illustrated in FIGS. 1 to 9 are not intended to limit the scope of the present invention. That is, all of the components or operations described in FIGS. 1 to 9 should not be interpreted as essential components to implement the present invention, and more or fewer of them may be used to implement the present invention within the scope of the present invention.

The above-described operations may be achieved by installing a memory unit storing corresponding program code in an arbitrary component of the navigation device or the UE. In other words, the control unit of the navigation device or the UE may read the program code stored in the memory unit and execute it by means of a processor or a Central Processing Unit (CPU), thereby performing the above-described operations.

The various components, modules, and the like of the navigation device or the UE which are described in the present disclosure may be operated by using a hardware circuit, for example, a combination of a complementary metal oxide semiconductor-based logical circuit, firmware, software and/or hardware, and/or a combination of firmware and/or software inserted into a machine-readable medium. As an example, various electrical configurations and methods may be carried out by using electrical circuits such as transistors, logic gates, and an Application Specific Integrated Circuit (ASIC).

While the present invention has been shown and described with reference to certain embodiments thereof, it will be understood by those skilled in the art that various changes in form and details may be made therein without departing from the scope and spirit of the present invention. Therefore, the scope of the present invention is not limited to the embodiments of the present invention, but is defined by the appended claims and equivalents thereof.

What is claimed is:

1. A method of updating a navigation device through communication with a user equipment (UE), comprising:
recognizing at least one of a location and an object as a point of interest (POI), based on a user preference which is set in advance or a user's input;
transmitting, to the UE, a request for additional data associated with the location or the object;
receiving, from the UE, the additional data associated with the location or the object through the communication; and
updating the navigation device using the additional data.

2. The method of claim 1, wherein updating the navigation device includes at least one of:
updating a database (DB) of the navigation device using the additional data,
mirroring an image provided from the UE on a screen of the navigation device using the additional data, and
outputting a window including one or more pieces of additional information indicated by the additional data to the whole or a part of the screen of the navigation device.

3. The method of claim 2, further comprising:
outputting the screen of the navigation device by disposing a window notifying an existence of additional information about the location or the object in a vicinity of a target corresponding to the location or the object.

4. A method of supporting update of a navigation device through communication with a user equipment (UE), comprising:
receiving a request for additional data associated with one or more locations or objects from the navigation device;
collecting the additional data associated with the one or more locations or objects from an information server on an Internet through cellular communication or Wireless Fidelity (Wi-Fi) communication; and
transmitting the collected additional data to the navigation device through the cellular communication or Wi-Fi communication.

5. The method of claim 4, wherein the location or the object is a location or an object recognized as a point of interest (POI) of a user based on a user preference set in advance or a user's input.

6. The method of claim 5, further comprising updating the navigation device using the additional data.

7. A navigation device for performing an update operation through communication with a user equipment (UE), the navigation device is configured to:
recognize at least one of a location and an object as a point of interest (POI) based on a user preference which is set in advance or a user's input;
transmit a request for additional data associated with the location or the object to the UE;
receive the additional data associated with the location or the object from the UE through the communication; and
update the navigation device using the additional data.

8. The navigation device of claim 7, wherein the navigation device is further configured to perform any one of:
updating a database (DB) of the navigation device using the additional data,
mirroring an image provided from the UE on a screen of the navigation device using the additional data, and
outputting a window including one or more pieces of additional information indicated by the additional data to the whole or a part of the screen of the navigation device.

9. The navigation device of claim 7, wherein the request for additional data includes information indicating a desired data format of the additional data.

10. The navigation device of claim 7, wherein the user preference is at least one of a new building, a new store, and a large building.

11. The navigation device of claim 7, wherein the communication is a peer to peer (P2P) communication.

12. The navigation device of claim 7, wherein the object is indicated by at least one of a geographical name and a building's name.

13. The navigation device of claim 7, wherein the received additional data is one of a data that is a result of a structured query language (SQL) query used in a database (DB) update, video streaming data, and web data.

14. The navigation device of claim 7, wherein the additional data includes at least one of map-related data used to update a navigation map and interest information about the location or the object.

15. The navigation device of claim 8, wherein the navigation device is further configured to dispose a window notifying an existence of additional information about the location or the object in a vicinity of a target corresponding to the location or the object in a screen of a display unit.

16. A user equipment (UE) for supporting update of a navigation device through communication, the UE is configured to:
receive a request for additional data associated with at least one of a location and an object from the navigation device;
collect the additional data associated with the location or the object from an information server on an Internet through cellular communication or Wireless Fidelity (Wi-Fi) communication; and
transmit the collected additional data to the navigation device through the cellular communication or the Wi-Fi communication.

17. The UE of claim 16, wherein the location or the object is a location or an object recognized as a point of interest (POI) of a user based on a user preference set in advance or a user's input.

18. The UE of claim 16, wherein the request for the additional data further includes information indicating a desired data format of the additional data.

19. The UE of claim 16, wherein the UE is a smartphone capable of driving a navigation application.

20. The UE of claim 16, wherein the cellular communication or Wi-Fi communication is a cellular communication or a Wi-Fi communication using an external network.
